(19) United States
(12) Patent Application Publication
(10) Pub. No.: US 2016/0120372 A1
(43) Pub. Date: May 5, 2016

(54) Method, cartridge and apparatus for mixing beverages

(71) Applicant: 4PLEASURE Ltd, London (GB)

(72) Inventor: Marco Lancellotti, Padova (IT)

(73) Assignee: 4PLEASURE LTD, London (GB)

(21) Appl. No.: 14/898,120

(22) PCT Filed: Jun. 28, 2013
(86) PCT No.: PCT/IB2013/055339

§ 371 Date: Dec. 12, 2015

(51) Int. Cl. A47J 43/27; B01F 3/08; C12G 3/04; B01F 15/02

(52) U.S. Cl. CPC A47J 43/27; B01F 15/0206; B01F 3/08; C12G 3/04

(57) ABSTRACT

A method for semi-automatic preparation of a range of standard cocktails and/or long drinks, wherein each cocktail is a mixture of liquid and/or creamy base components, dosed according to official international standards, said method comprising at least the steps of a) providing a plurality of empty stackable capsules (2), b) filling each capsule (2) with one or more standardized doses (D) of individual base components (B) of the cocktail to be prepared, c) sealing said capsules (2) with frangible walls (3, 4) d) arranging said filled capsules (2) one on top of the other to form a stack (5), e) sequentially piercing said capsules (2) to cause the base components (B) contained therein to flow out, f) collecting the base components (B) of all the capsules into a single receptacle (6), g) mixing the base components (B) collected in said receptacle (6) to obtain the cocktail, h) transferring the cocktail into a container for consumption by a user. The empty capsules (2) have identical plan shapes and different heights (h₁₋₅), to define a limited number of capsule sizes (M₁₋₅) having different volumes (V₁₋₅), each capsule size (M₁₋₅) being dimensioned to contain a unit dose (D) of a base component of predetermined value, for preparing all the cocktails of the range, in combination with the other capsules (2) of the stack (5).

### FIELD OF THE INVENTION

The present invention generally finds application in the field of beverage preparation and particularly relates to a method for semi-automatic preparation of standard cocktails and/or long drinks. The invention also relates to an apparatus and a cartridge for preparing standard cocktails in accordance with the above method.

### BACKGROUND ART

Methods are known, in the field of beverage preparation and distribution, for preparing alcoholic or non-alcoholic cocktails by mixing a predetermined amount of liquid and/or creamy base components.

Particularly, these methods allow preparation of standard cocktails from amounts of base components that are as close as possible as the doses required by the official international standard defined by the International Bartenders Association (IBA).

This association currently defines an official list of seventy-four different types of standard alcoholic cocktails or long drinks, which are divided into the categories Unforgettables, Contemporary Classic and New Era Drink, and defines precise doses of the base components for each of them.

For example, according to this official international standard, the well-known standard cocktail known as “Negroni” is obtained by mixing 30 ml gin, 30 ml Campari® and 30 ml Vermut® Rosso.

Devices are known which help to prepare various types of cocktails using capsules containing a fixed and predetermined amount of base components.

These devices afford cocktail preparation without requiring the user to pour the base components into the glass directly from the bottle. This considerably increases the precision of the amounts of base products that are used during cocktail preparation.

CH 6312066 discloses an apparatus for preparing cocktails which comprises a plurality of single-dose capsules of base components having identical capacities, i.e. 1 cl, and each having a pair of frangible walls.

The apparatus also comprises a mixing zone, with a funnel-shaped housing designed to support a predetermined number of stacked capsules, each containing a unit dose of a base component of the cocktail that has to be prepared.

The apparatus finally comprises a pointed actuator that is designed to be actuated by the user to pierce the capsules of the stack to cause all the unit doses of components to flow out. Such doses are collected in a receptacle located below the housing, to make the cocktail ready for consumption.

A first drawback of this solution is that single-dose capsules have a fixed, unchangeable capacity.

Thus, in order to prepare a given number of different cocktails, multiple capsules containing the same base components must be placed in the device, which will not allow accurate preparation of cocktails that require, for one or more components, fractions of centiliters, such as 0.2 cl or 0.5 cl.

A further drawback of this arrangement is that stacking of equally sized capsules changes and considerably increases the overall dimensions of the device, and creates a large amount of waste after piercing.

Furthermore, in order to prepare many different cocktails, a great number of capsules are required, which have a non-negligible weight and require a relatively large storage space.

These drawbacks may considerably restrict the use of the device in particular means of transport, such as aircrafts or trains, which have narrow spaces and do not allow transportation of unnecessary or niche products having a heavy weight.

A further important drawback of this arrangement is that the housing for the capsules is open, which might facilitate contamination of the base components in the capsules with foreign agents during piercing, thereby affecting preparation hygiene.

### DISCLOSURE OF THE INVENTION

The main object of the present invention is to obviate the above drawbacks, by providing a method of preparing cocktails and long drinks that is highly efficient and relatively cost-effective.

A particular object of the present invention is to provide a method of preparing cocktails that allows preparation of all types of standard cocktails in compliance with the official doses, as well as newly formulated recipes, in a highly accurate and semi-automatic manner.

A further object of the present invention is to provide a method that allows preparation of cocktails in particularly narrow environments, e.g. in cars, buses, trains, aircrafts and boats.

Yet another object of the present invention is to provide a method of preparing cocktails that minimizes the waste generated after each cocktail.

A further important object of the present invention is to provide a method that allows cocktail preparation with a high degree of hygiene.

These and other objects, as better explained hereinafter, are fulfilled by a method for preparing a range of standard cocktails and/or long drinks, wherein each cocktail is a mixture of dosed liquid and/or creamy base components, as defined in claim 1, which method comprises at least one step of providing a plurality of empty stackable single-dose capsules; a step of filling each capsule with a standardized dose of individual base components of the cocktail to be prepared, a step of sealing each capsule with frangible walls; a step of arranging said capsules one on top of the other to form a stack (5); a step of sequentially piercing said single-dose capsule to cause the base component contained therein to flow out, a step of collecting the base components of all the capsules into a single receptacle; a step of mixing the base components collected in said receptacle to obtain the cocktail, and a step of transferring the cocktail into a container for consumption by a user.

Preferably the single-dose capsules have identical plan shapes and different heights, to define a limited number of single-dose capsule sizes having different volumes, each single-dose capsule size being dimensioned to contain a unit dose of a base component of predetermined value, for accurate preparation of all the cocktails in combination with the other capsules of the stack.

In a further aspect, the invention relates to an apparatus for preparing cocktails, as defined in claim 8.

In yet another aspect, the invention provides a cartridge for preparation of one or more cocktail doses, as defined in claim 13.

Advantageous embodiments of the invention are obtained in accordance with the dependent claims.

### BRIEF DESCRIPTION OF THE DRAWINGS

Further features and advantages of the invention will be more apparent from the detailed description of a preferred, non-exclusive embodiment of the method, apparatus and cartridge for preparing cocktails according to the invention, which is described as a non-limiting example with the help of the annexed drawings, in which:

FIG. 1 is a flow diagram of the method of the invention;

FIG. 2 is a partially broken-away side view of the listed capsules that are used in the method of FIG. 1;

FIGS. 3, 4 and 5 are side views of capsules of different sizes to prepare different types of cocktails;

FIG. 6 is a perspective view of a cartridge for preparing cocktails according to the invention;

FIGS. 7 and 8 are broken-away side views of an apparatus for preparing cocktails according to the invention, in inoperative and operative positions respectively;

FIG. 9 is a partially broken-away side view of a first detail of FIG. 7;

FIGS. 10 and 11 are perspective views of a second detail of FIG. 8;

FIG. 12 is a partially broken-away side view of a third detail of FIG. 7;

FIG. 13 is a partially broken-away side view and a top view of a fourth detail of FIG. 7;

FIG. 14 is a partially broken-away side view and a side view of a fifth detail of FIG. 7;

### DETAILED DESCRIPTION OF A PREFERRED EMBODIMENT

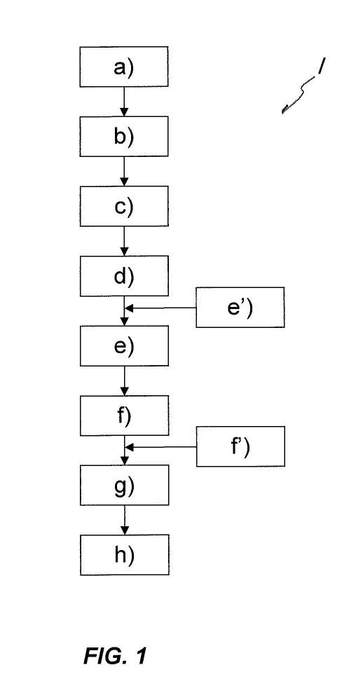

Referring to the flow diagram of FIG. 1, there is shown a method for standardized preparation of cocktails, which is adapted to allow preparation of alcoholic and/or non-alcoholic cocktails from a mixture of liquid and/or creamy base components B.

Particularly, the method allows cocktails and long drinks to be prepared using doses of base components B corresponding to the official international standards established by the IBA (International Bartenders Association), which is the most important international organization in the field of preparation of alcoholic beverages in general.

Particularly, the method 1 for standardized preparation of cocktails according to the invention comprises the steps of:
a) providing a plurality of empty stackable capsules 2;
b) filling each capsule 2 with one or more standardized doses D of individual base components B of the cocktail to be prepared;

c) sealing the capsules 2 with frangible walls 3, 4;

d) arranging the capsules 2 one on top of the other to form a stack 5.

Once the capsules have been stacked, the method comprises a step of e) sequentially piercing the capsules 2 to allow the base components B contained therein to flow out.

For this purpose, the capsules 2 may comprise a pair of opposed frangible walls 3, 4, which are both designed to be pierced during the piercing step e).

The step of e) piercing is followed by a step f) of collecting the base components B of all the capsules 2 into a single receptacle 6 and a step g) of mixing the base components B collected in such receptacle 6 to prepare the desired cocktail.

Furthermore, the step g) of mixing is followed by a step h) of transferring the cocktail from the receptacle 6 into a container or glass, not shown, for consumption by a user.

Particularly, in the step d) of stacking, the capsules 2 may be piled up vertically and the step f) of collecting the base components B may be carried out in a single receptacle 6 located below the stack 5 of capsules 2.

Preferably, before the step e) of piercing, the method of the invention may comprise an additional step e′) of adding ice cubes or crushed ice, into the receptacles and an additional step f′) of adding further natural flavor garniture components, which is carried out after the step of collecting f).

These natural flavors of the garniture 7 may include salt grains, tobacco powder, mint leaves or other similar products.

According to a peculiar feature of the invention, the empty capsules 2 may have the same plan shape and different heights h₁₋₅, to define a limited number of capsule sizes M₁₋₅ having different volumes V₁₋₅.

Particularly, each capsule size is dimensioned to contain a unit dose D of a base component of predetermined value, which may be used to accurately prepare all the official cocktails, in combination with the other capsules 2 of the stack 5.

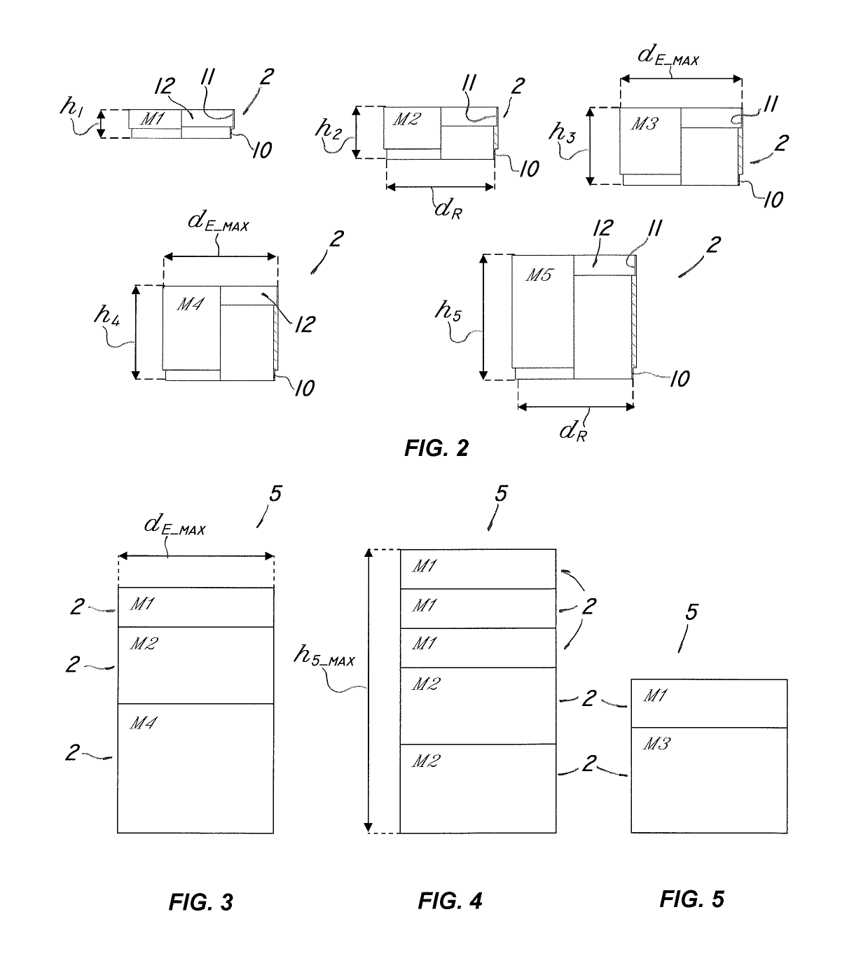

Conveniently, as better shown in FIG. 2, the number of capsule sizes M₁₋₅ may range from four to eight and is preferably five.

Particularly, all the types of cocktails provided by the I.B.A. may be prepared using five different capsule sizes M₁₋₅.

Preferably, as shown in FIG. 2, the capsules may have a substantially cylindrical tubular shape, with a maximum outside diameter d_{E}_{_}ₘₐₓ substantially close to 5 cm and different heights h₁₋₅ ranging from a minimum value of 1 cm to a maximum value of about 5 cm.

In the illustrated configuration of the invention, each capsule 2 has a maximum outside diameter of 5.5 cm and has a pair of substantially flat frangible walls 3, 4 at the end openings 8, 9.

Furthermore, the tubular capsules 2 may have a bottom end portion 10 with a reduced diameter dR and a housing 11 formed in the top end portion 12.

Particularly, in the step d) of stacking, the reduced-diameter dR bottom end portion 10 of a capsule 2 may fit into the housing 11 of the underlying capsule.

Conveniently, as better shown in the following Table I, each capsule M₁₋₅ may be configured to contain an amount of the base component B ranging between predetermined minimum and maximum values.

TABLE I

| Standard | Height | Amount of base |
|---|---|---|
| capsule size | h₁₋₅ (cm) | component (cl) |
| M1 | 1 | 0.50-2.00 |
| M2 | 2 | 2.50-4.50 |
| M3 | 3 | 5.00-6.00 |
| M4 | 4 | 7.50-9.00 |
| M5 | 5 | 10.00-12.00 |

For example, as clearly shown in Table I, the standard-size capsule M₁ having a height of 1 cm will be used to contain doses of base components B smaller than 2 cl, whereas the standard-size capsule M₂, having a height of 2 cm, will be used to contain amounts of base components B from 2.5 cl to 4.5 cl.

Also, the capsules having heights of 3 cm, 4 cm and 5 cm, defining the capsule sizes M₃, M₄, M₅ are dimensioned to contain base component amounts ranging from 5 cl to 6 cl, from 7.5 cl to 9 cl and from 10 cl to 1 cl respectively.

Preferably, the capsules 2 may have volumes V₁₋₅ ranging from a minimum value of 30 cm³ to a maximum value of 140 cm³.

Particularly, the volumes V₁₋₅ allow the capsules 2 to contain amounts of base component B ranging from 0.5 cl to 12 cl.

The use of five distinct capsule sizes from M₁ to M₅, whose dimensions are shown in Table I, was experimentally found to allow highly accurate preparation of any type of cocktail using a stack 5 of capsules 2 having particularly small dimensions.

A few examples of cocktail preparation using the capsule sizes M₁-M₅ as defined in Table I are provided below.

### EXAMPLE 1

### Preparation of a Bloody Mary

According to IBA international standard, the cocktail known as “Bloody Mary” is composed of 4.5 cl Vodka, 9 cl Tomato juice and 1.5 cl Lemon juice.

This cocktail, as better shown in FIG. 3, may be prepared by stacking a M₁-size capsule 2 containing lemon juice, a M₂-size capsule 2 containing vodka and a M₄-size capsule 2 containing tomato juice.

### EXAMPLE 2

### Preparation of a Mai Tai

According to IBA international standard, the cocktail known as “Mai Tai” is composed of 1 cl lime juice, 1.5 cl orgeat syrup, 1.5 cl orange curacao, 3 cl dark rum, 3 cl white rum.

This cocktail, as better shown in FIG. 4, may be prepared by stacking three M₁-size capsules 2 containing lime juice, orgeat syrup and orange curacao respectively and two M₂-size capsules 2 each containing one rum type.

### EXAMPLE 3

### Preparation of a Vodka Martini

According to the IBA international standard, the cocktail known as “Vodka Martini” is a mixture of 5.5 cl vodka and 1.5 cl dry vermut Martini®.

This cocktail, as better shown in FIG. 5, may be prepared by stacking a M₁-size capsule 2 containing dry vermut Martini®, and a M₃-size capsule 2 containing vodka.

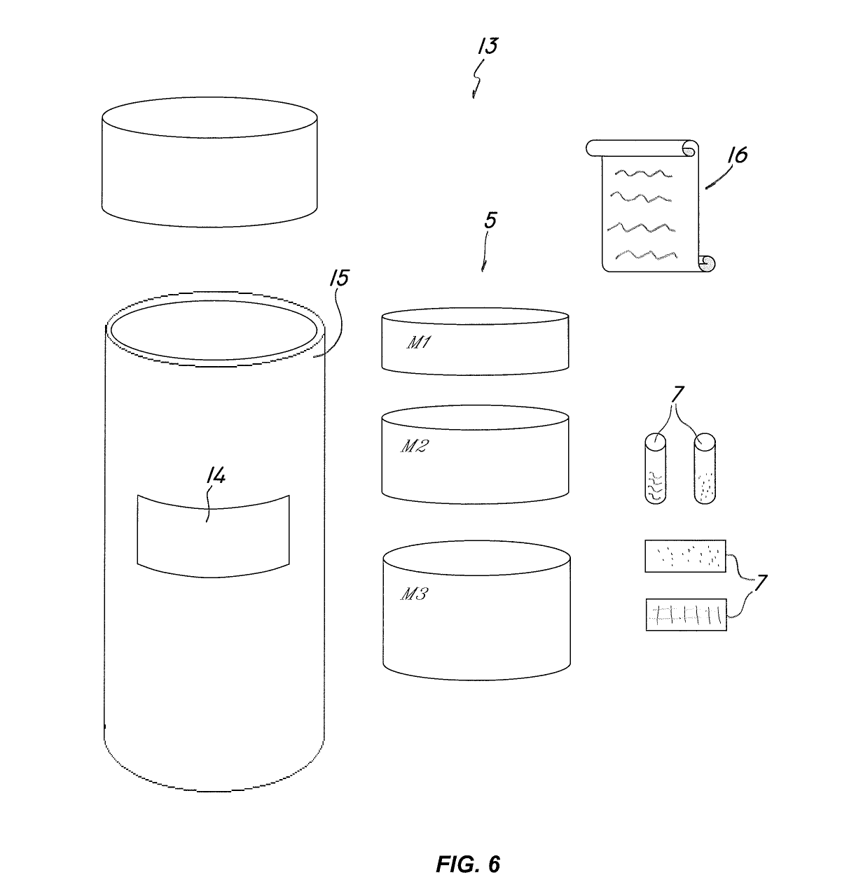

In a further aspect, as shown in FIG. 6, the invention provides a cartridge for cocktail preparation, generally referenced 13, for preparing one or more cocktail doses D.

The capsule 13 may be defined by a stack 5 of capsules 2 packaged into a single unit, and may be distinguished by a recognition string 14 designed to identify a given standard cocktail or long drink to be prepared.

Particularly, the cartridge 13 may comprise a stack 5 of substantially cylindrical capsules having the same plan shape and equal or different heights h₁₋₅, each containing at least one official standard dose D of an individual base component B. Particularly, the cartridge 13 may include a stack 5 of capsules having M₁ to M₅ sizes, as defined in Table I.

Conveniently, the cartridge 13 may comprise a tubular package 15 distinguished by the recognition string 14 and adapted to contain the stack 4 of cylindrical capsules 2.

Also, the package of the cartridge 13 may have one or more garniture components 7 therein, such as salt, pepper, mint or tabasco, which are designed to garnish the cocktail before consumption by the user.

Finally, the package of the cartridge 13 may also include a leaflet 16 containing general information about the cocktail and its official recipe.

Conveniently, each capsule 2 of the cartridge 13 may contain a plurality of official standard doses D for each individual base component B, to allow preparation of a cocktail for more than one person.

Alternatively, the cartridge 13 may comprise two or more capsules 2 of equal size containing the same amount of the same base product B to allow distinct preparation of multiple doses D of the same cocktail.

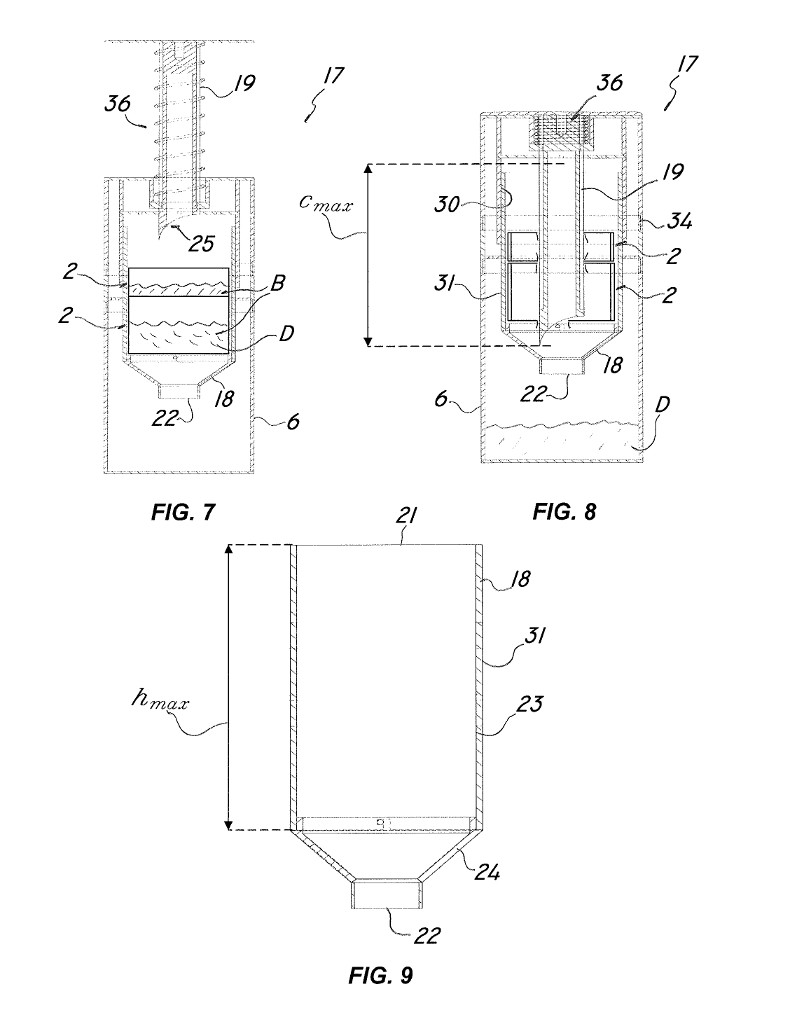

In a further aspect, the invention relates to an apparatus 17 for cocktail preparation, as better shown in FIGS. 7 and 8, which is designed to mix a plurality of liquid and/or creamy base components B in doses D contained in the above described capsules 2.

The apparatus 17 comprises a support element 18 for supporting a stack 5 of capsules 2 selected from those designed for preparation of a given cocktail and a perforator tool 19 controllably movable and adapted to sequentially pierce the frangible walls 3, 4 of all the capsules 2 of the stack 5. Furthermore, the apparatus 17 comprises a collection receptacle 6, for collecting the base components B flowing out of the capsules 2 due to the operation of the perforator tool 19.

According to a peculiar aspect of the apparatus 17, the perforator tool 19 and the receptacle 6 are adapted to be removably associated with the support element 18 to form a closed, one-piece device. Furthermore, the support element 18 may have a maximum height hₘₐₓ greater than the maximum height h₅_{_}ₘₐₓ of the stacks 5 of capsules 2 of all the cocktails.

Thus, the closed, one-piece device 17 will allow highly hygienic cocktail preparation, with protection from any foreign contaminants.

In a particularly advantageous aspect, the apparatus 17 may be used in combination with a cartridge for preparation of cocktail doses D as described above.

Conveniently, as better shown in FIG. 9, the support element 18 may have a substantially cylindrical tubular shape, with an upper opening 21 for introducing the stack 5 of capsules 2 and a lower opening 22 for transferring the base components B to the receptacle 6.

Furthermore, the support element 18 may comprise an upper cylindrical portion 24 with the upper opening 21 joined to a lower funnel-shaped tapered portion 24 with the lower opening 22.

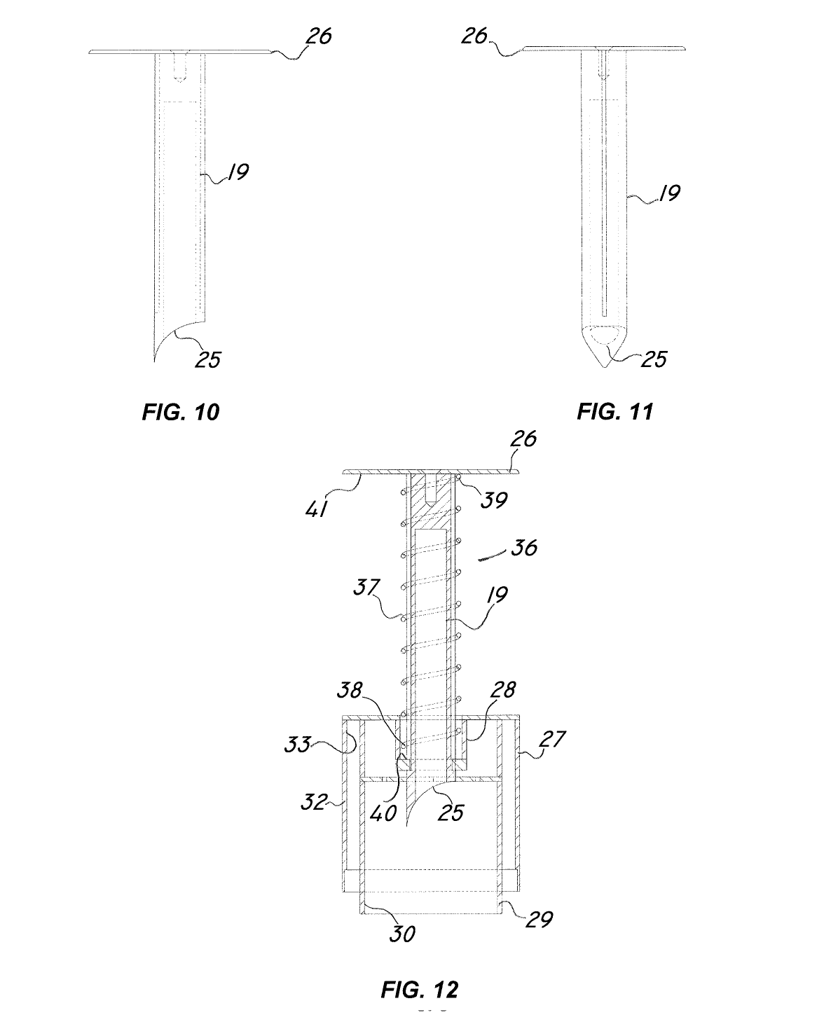

Conveniently, the perforator tool 19 may have a substantially cylindrical shape and be formed with a sharp bottom end 25, as better shown in the views of FIGS. 10 and 11, for piercing the frangible walls 4, 5 of the capsules 2 of the stack 5.

Furthermore, the perforator tool may have a thrust wall 26, as shown in FIGS. 10 and 11, which is designed to be pushed downwards by a user's hand.

Conveniently, the apparatus 17 may comprise a cover 27, as better shown in FIG. 12, which is designed to be removably engaged with the support element 18 and the receptacle 6 and is formed with a slide seat 28 for the perforator tool 19.

Particularly, the cover 27 may have a cylindrical wall 29 with a first inner surface 30 adapted for removable engagement of the outer surface 31 of the support element 18.

Furthermore, the cover 27 may have an outer cylindrical wall 32, coaxial with the inner wall 29 and having a second inner surface 33 adapted for removable engagement of the outer surface 34 of the receptacle 6.

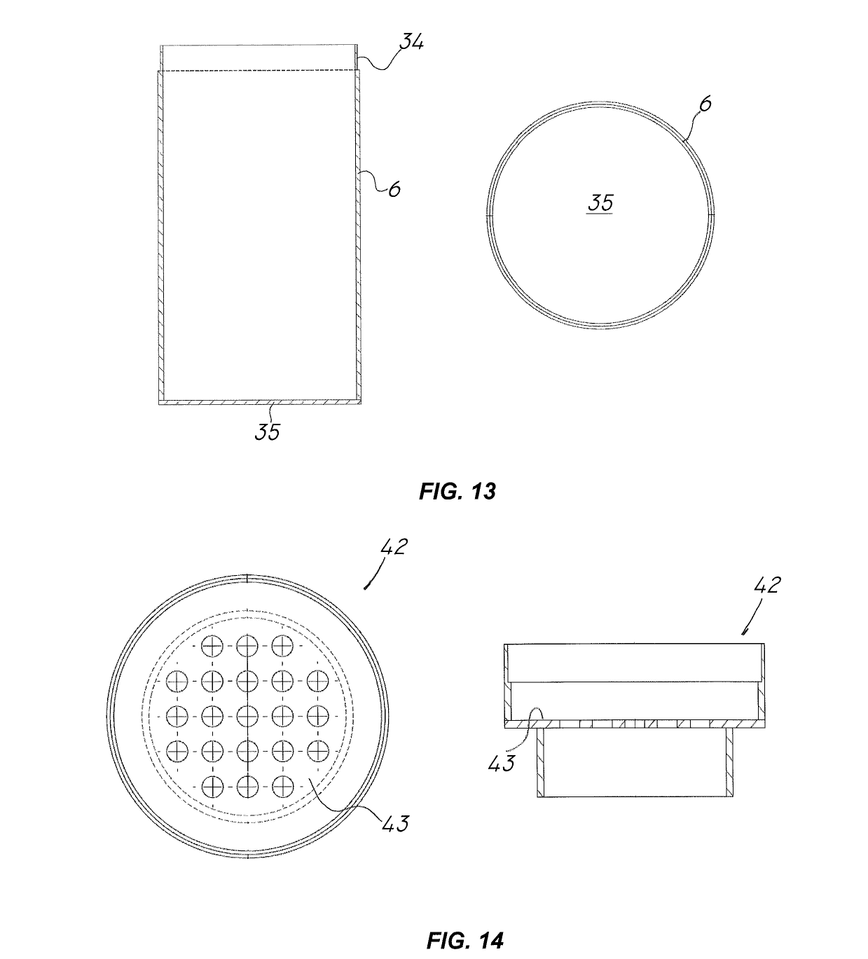

As better shown in FIG. 13, the receptacle 6 may have a substantially cylindrical shape, and may comprise a substantially flat bottom wall 35.

The perforator tool 19, as better shown in FIGS. 7 and 8, may be axially movable in the tubular support element 18 between an upper position in which the sharp end 25 thereof is placed above the upper opening 21 and a lower position in which the sharp end 25 is close to the lower opening 22.

Thus, the perforator tool 19 may axially slide within the support element 18 with a sufficient maximum stroke cₘₐₓ to allow piercing of the frangible walls 3, 4 of all the capsules 2 in the stack 5.

Advantageously, the perforator tool 19 may comprise automatic return means 36, allowing it to move back from the lower position to the upper position.

Particularly, as better shown in FIG. 12, the automatic return means 36 may include a spring 37 having ends 38, 39 interacting with the inner edge 40 of the slide seat 28 and the underside 41 of the thrust wall 26 respectively.

Conveniently, the apparatus 17 may comprise a substantially cylindrical intermediate element 42, as shown in FIG. 14, which is adapted to be removably associated with the receptacle 6 and comprises an intermediate perforated wall 43. The perforated wall 43 allows the base components B that were mixed in the receptacle 6 to be transferred to the container for consumption by the user, while preventing the passage of ice or further solid components in the receptacle 6.

The above disclosure clearly shows that the method, apparatus and cartridge of the invention fulfill the intended objects and particularly the object of preparing a range of cocktails or long drinks in a standardized, semi-automatic manner, using base components in doses exactly corresponding to IBA international standards.

The method, apparatus and cartridge of the invention are susceptible to a number of changes or variants, within the inventive concept as disclosed in the appended claims. All the details thereof may be replaced by other technically equivalent parts, and the materials may vary depending on different needs, without departure from the scope of the invention.

While the method, apparatus and cartridge have been described with particular reference to the accompanying figures, the numerals are only used for the sake of a better intelligibility of the invention and shall not be intended to limit the claimed scope in any manner.

1. A method for semi-automatic preparation of a range of standard cocktails and/or long drinks, wherein each cocktail is a mixture of liquid and/or creamy base components (B), dosed according to official international standards, said method comprising at least the steps of:
a) providing a plurality of empty stackable capsules (2);
b) filling each capsule (2) with one or more standardized doses (D) of individual base components (B) of the cocktail to be prepared;
c) sealing said capsules (2) with frangible walls (3, 4);
d) arranging said capsules (2) one on top of the other to form a stack (5);
e) sequentially piercing said capsules (2) to cause the base components (B) contained therein to flow out;
f) collecting the base components (B) of all the capsules into a single receptacle (6);
g) mixing the base components (B) collected in said receptacle (6) to obtain the cocktail;
h) transferring the cocktail into a container for consumption by a user;
wherein said empty capsules (2) have identical plan shapes and different heights (h₁₋₅), to define a limited number of capsule sizes (M₁₋₅) having different volumes (V₁₋₅), each capsule size (M₁₋₅) being dimensioned to contain a unit dose (D) of a base component of predetermined value, for preparing all the cocktails of the range, in combination with the other capsules (2) of the stack (5).

2. A method as claimed in claim 1, characterized in that the number of capsule sizes (M₁₋₅) ranges from four to eight and is preferably five.

3. A method as claimed in claim 2, characterized in that the volumes V₁₋₅ of said capsule sizes range from a minimum value of 30 cm³ to a maximum value of 140 cm³.

4. A method as claimed in claim 1, characterized in that said capsules have a substantially cylindrical tubular shape, with a maximum outside diameter (d_{E}_{_}ₘₐₓ) substantially close to 5 cm and different heights h₁₋₅ ranging from a minimum value of 1 cm to a maximum value of about 5 cm.

5. A method as claimed in claim 1, characterized in that said stack (5) of capsules (2) is packaged into a one-piece cartridge (13), which is distinguished by a recognition string (14) identifying the cocktail to be prepared.

6. A method as claimed in claim 1, characterized in that said step e) of piercing is preceded by a step e′) of adding ice cubes or crushed ice into said receptacle (6).

7. A method as claimed in claim 1, characterized in that said step f) of collecting is followed by a step f′) adding additional garniture components (7).

8. An apparatus (17) for semiautomatic preparation of a range of standard cocktails and/or long drinks by mixing a plurality of liquid or creamy base components (B) in doses (D) corresponding to official international doses, wherein said doses (D) are contained in substantially cylindrical sealed capsules (2) having frangible end walls (3, 4), wherein the apparatus comprises:
a support element (18) for supporting a stack (5) of capsules (2) selected from those designed for preparation of a given cocktail;
a perforator tool (19) controllably movable to sequentially pierce the frangible walls (3, 4) of all the capsules (2) of the stack (5);
a collection receptacle (6), for collecting the base components (B) flowing out of said capsules (2) due to the operation of said perforator tool (19);
characterized in that said perforator tool (19) and said receptacle (6) are adapted to be removably associated with said support element 18 to form a closed, one-piece device, adapted to ensure highly hygienic conditions, said support element (18) having a maximum height (hₘₐₓ) greater than the maximum height (h₅_{_}ₘₐₓ) of the stacks (5) of capsules (2) of all the cocktails.

9. An apparatus as claimed in claim 8, characterized in that said support element (18) has a substantially cylindrical tubular shape, with an upper opening (21) for introducing said stack (5) of capsules (2) and a lower opening (22) for transferring the base components (B) to said receptacle (6).

10. An apparatus as claimed in claim 8, characterized in that said perforator tool (19) has a sharp bottom end (25) for piercing the frangible walls (3, 4) of the capsules (2) of said stack (5).

11. An apparatus as claimed in claim 10, characterized in that said perforator tool (19) is axially movable in said tubular support element (18) between an upper position in which its sharp end (25) thereof is placed above said upper opening (21) and a lower position in which its sharp end (25) is close to said lower opening (22).

12. An apparatus as claimed in claim 11, characterized in that said perforator tool (19) comprises automatic return means (36) for moving it back from said lower position to said upper position.

13. A cartridge (13) for semiautomatic preparation of cocktails, designed for use in combination with an apparatus (17) as claimed in one or more of claims from 8 to 12, wherein the cartridge (13) comprises a stack (5) of substantially cylindrical capsules (2) having the same plan shape and equal or different heights (h₁₋₅), each containing at least one official standard dose (D) of an individual base component (B) of the cocktail, said stack (5) of capsules (2) being packaged into a one-piece package, which is distinguished by a recognition string (14) identifying the cocktail to be prepared.

14. A cartridge as claimed in claim 13, characterized in that each capsule (2) contains a plurality of official standard doses (D) of an individual base component (B), for semiautomatic preparation of a standard cocktail or long drink for one or more persons.
